(19) United States
(12) Patent Application Publication
(10) Pub. No.: US 2023/0367003 A1
(43) Pub. Date: Nov. 16, 2023

(54) Method and System for Tracking Extended Objects

(71) Applicant: Bayerische Motoren Werke Aktiengesellschaft, Muenchen (DE)

(72) Inventors: Philipp BERTHOLD, Pfaffenhofen a. d. Ilm (DE); Daniel MEISSNER, Friedberg (DE); Martin MICHAELIS, Hoehenkirchen-Siegertsbrunn (DE)

(21) Appl. No.: 18/044,439

(22) PCT Filed: Aug. 18, 2021
(86) PCT No.: PCT/EP2021/072943

§ 371 Date: Mar. 8, 2023

(30) Foreign Application Priority Data
Sep. 9, 2020 (DE) 10 2020 123 527.5

(51) Int. Cl. G01S 13/72; G01S 13/931

(52) U.S. Cl. CPC G01S 13/72; G01S 13/931

(57) ABSTRACT

A method for tracking extended objects in the surroundings of a vehicle includes the steps of: (a) providing modeled components for an object; (b) determining a detection from sensor data; and (c) determining the origin of the detection on the object using the modeled components. The process of determining the origin of the detection on the object includes determining association probabilities for the plurality of modeled components, in which the association probabilities indicate the degree of probability with which the detection is associated with the individual components of the modeled components.

### CROSS REFERENCE TO RELATED APPLICATION

This application is a 371 of International Application No. PCT/EP2021/072943, filed Aug. 18, 2021 which claims priority under 35 U.S.C. § 119 from German Patent Application No. 10 2020 123 527.5, filed Sep. 9, 2020, the entire disclosure of which is herein expressly incorporated by reference.

### BACKGROUND AND SUMMARY OF THE INVENTION

The present disclosure relates to a method for tracking extended objects, to a storage medium for carrying out the method, to a system for tracking extended objects, and to a vehicle having such a system. The present disclosure relates, in particular, to a process of tracking extended objects in vehicle surroundings using an abstracted radar measurement model by means of probabilistic component association.

### PRIOR ART

Driving assistance systems for automated driving are steadily gaining importance. Automated driving can be carried out with different degrees of automation. Exemplary degrees of automation are assisted, partially automated, highly automated or fully automated driving. These degrees of automation were defined by the German Federal Highway Research Institute (BASt) (see BASt publication “Forschung kompakt”, November 2012 edition). By way of example, vehicles with level 4 are on the road fully autonomously during city operation.

The driving assistance system for automated driving uses sensors which visually sense the environment, both in the range visible to humans and in the invisible range. The sensors may be, for example, a camera, a radar, a laser scanner and/or a LiDAR. The environmental data captured by the sensors are used, inter alia, to track objects. During object tracking, objects in the surroundings of the vehicle, for example other vehicles, are detected and their movements are tracked.

A great challenge when tracking objects is the assignment of a point measurement to its true origin on a target object. The origins of measurements are often spatially distributed over the entire extent of the target object. It is difficult to assign measurements to the possible origins within the extent of the target object, in particular in the case of low-resolution sensors which provide only a few measurements for each object.

There are some approaches for tracking extended objects. In this case, an extended object means that the sensor resolution can resolve more than one individual point measurement for each object. For example, a sensor senses a plurality of reflections for each object and outputs these reflections as measurement data. In order to filter these measurement data, the origin of a point measurement, which is generally referred to as a “detection”, must be known. Many detections are available in the case of high-resolution sensors. The object contour is often discernible in the measurement data in this case, and so the object can be identified relatively reliably.

Usually only a few detections are discernible in mass-produced sensors, in particular radar sensors, and the measurement data alone are insufficient to estimate the object state. In this case, it is possible to use, for example, a radar measurement model which describes what object state and what object structure produce which measurement data. This knowledge can be used in a Bayesian filter to infer an object state from measurement data. However, such radar measurement models are very computationally intensive and can be used, for example, only together with a particle filter which is likewise computationally intensive.

### DISCLOSURE OF THE INVENTION

It is an object of the present disclosure to specify a method for tracking extended objects, a storage medium for carrying out the method, a system for tracking extended objects and a vehicle having such a system, which make it possible to track extended objects with reduced computing resources and/or in a reduced amount of time. Furthermore, it is an object of the present disclosure to improve reliability and therefore safety of a driving assistance system for automated driving.

This object is achieved by means of the subject matter of the independent claims. Advantageous configurations are specified in the subclaims.

According to an independent aspect of the present disclosure, a method for tracking extended objects, in particular in vehicle surroundings, is specified. The method comprises providing a multiplicity of modeled components for an (individual) object; determining a detection from sensor data; and determining an origin of the detection on the object using the multiplicity of modeled components. The determination of the origin of the detection on the object comprises determining association probabilities for the multiplicity of modeled components, wherein the association probabilities indicate the probability with which the detection is associated with the individual components of the multiplicity of modeled components.

According to the invention, a plurality of components are modeled for an individual object, such as a vehicle. The plurality of components may comprise, for example, at least one wheel, at least one vehicle corner and at least one vehicle side. Association probabilities for each of these components are then determined for an individual detection obtained from real sensor data. In other words, a probabilistic association that can be determined quickly and with little computing complexity is carried out. This makes it possible to track extended objects with reduced computing resources and in a reduced amount of time.

The term “extended object”, as used in the context of the present disclosure, means that a sensor resolution can be used to resolve more than one individual point measurement for each object. For example, a LiDAR sensor or a RADAR sensor senses a plurality of reflections for each object and outputs these reflections as sensor data or measurement data.

The object which can be tracked by means of the method according to the invention may be, in particular, a moving object, for example a vehicle, a motorcycle, a truck, a cyclist etc. However, the present disclosure is not restricted thereto and may involve a different object which is detected, for example during automated driving of an (ego) vehicle, in the area surrounding the latter.

The components of the object may be modeled by means of a suitable measurement model. Such a measurement model indicates which components of the object produce detections with a particular probability of a particular state estimation. A complex and spatially dependent detection probability, which depends on various (in particular physical) parameters, can therefore be described by a set of modeled components.

In some embodiments, the object may be a(nother) vehicle. The multiplicity of modeled components are preferably selected from the group comprising, or consisting of, a vehicle wheel, a vehicle corner and a vehicle side. For example, the (other) vehicle can be described by twelve components, specifically four wheels, four vehicle corners and four vehicle sides.

At least one component of the multiplicity of modeled components is preferably modeled by a point target, optionally with a Gaussian noise term. For example, the wheels and/or the vehicle corners are described with such a point target. In this case, the extent may be described with a Gaussian noise term of an appropriate level and orientation. The superposition of the spatial detection probabilities in this case preferably corresponds to the spatial detection probability from an accurate radar measurement model.

The association probabilities are preferably input into a probabilistic data association filter (PDAF). The PDAF uses the association probabilities, but does not calculate them. Depending on the application, the association probabilities can be calculated or modeled using suitable methods.

A conventional PDAF is a statistical approach for the problem of association in a target tracking algorithm. According to the invention, the conventional PDAF approach, which involves assigning a multiplicity of (uncorrelated) detections to an individual object, is reversed such that an individual recorded detection is now assigned to a multiplicity of components of an individual object.

In particular, a detection must be assigned to its origin on the object so that the measurement can provide information about the current object position and object orientation. On account of the uncertainty of the object estimation and measurement noise, an association is not possible with complete reliability. According to the invention, association probabilities of the detection belonging to a particular component are calculated using the probabilistic data association filter.

The determination of the origin of the detection on the object preferably also comprises updating a state estimation relating to the object using the association probabilities. In particular, an association probability is calculated for each component, wherein an improvement in the state estimation can be calculated assuming that this component is actually the origin of the detection.

In some embodiments, the updates of the state estimations can be weighted with a normalized probability for the respective component.

At least one component of the multiplicity of modeled components is preferably subdivided into a multiplicity of subcomponents, wherein a corresponding association probability is determined for each subcomponent of the multiplicity of subcomponents.

For example, vehicle sides can be modeled by means of subcomponents. Whereas wheels and corners can be modeled with a noise term, as described, the line for this is too large. Since the mean value of the detection probability is in the middle in the case of Gaussian modeling, detections at the edge of the line would be assigned to the middle of the component, which would cause a high bias in the case of the vehicle side.

The vehicle sides are therefore preferably modeled as a subset of components (subcomponents), wherein each subcomponent corresponds to a point on a line which can represent the vehicle side. It is therefore possible to model different parts of the line as separate detection sources. This results in association equations for n points on the line in accordance with the component association described above.

In some embodiments, an integral can be used to integrate association equations along the line, instead of a discrete number of association equations. This corresponds to a limit value function which can allow n to run toward infinity. This analytical function can be resolved in a closed manner in the case of a line and can therefore be carried out particularly quickly. In contrast to a set of discrete association equations, it is not subject to any discretization errors in this case.

The sensor data which contain the detection are preferably provided by at least one sensor. In this case, the at least one sensor may comprise a LiDAR sensor and/or a RADAR sensor. In contrast to high-resolution sensors, often only a few detections are discernible in the case of LiDAR and RADAR sensors. The embodiments of the present disclosure are advantageous for such sensors, in particular, since reliable object tracking is possible here even with a few detections.

In some embodiments, the at least one sensor may be included in an environmental sensor system of a vehicle. In this case, the environmental sensor system is configured to provide surroundings data (also referred to as “environmental data”) which represent an area surrounding the vehicle. The environmental sensor system preferably comprises at least one LiDAR system and/or at least one radar system and/or at least one camera and/or at least one ultrasonic system and/or at least one laser scanner, but is not restricted thereto.

According to a further independent aspect of the present disclosure, a software (SW) program is specified. The SW program may be configured to be executed on one or more processors and to thereby carry out the method described in this document for tracking extended objects, in particular in a vehicle environment.

According to a further independent aspect of the present disclosure, a storage medium is specified. The storage medium may comprise a SW program which is configured to be executed on one or more processors and to thereby carry out the method described in this document for tracking extended objects.

According to a further independent aspect of the present disclosure, software having program code for carrying out the method for tracking extended objects can be executed if the software runs on one or more software-controlled devices.

In this case, a processor is a programmable arithmetic unit, that is to say a machine or an electronic circuit which controls other elements according to transferred commands and in so doing drives an algorithm (process).

According to a further independent aspect of the present disclosure, a system for tracking extended objects is specified. The system comprises one or more processors which are configured to thereby carry out the method described in this document for tracking extended objects, in particular in a vehicle environment.

According to a further independent aspect of the present disclosure, a vehicle, in particular a motor vehicle, is specified. The vehicle comprises the system for tracking extended objects according to the embodiments of the present disclosure.

The term “vehicle” covers automobiles, trucks, buses, motorhomes, motorcycles, etc. which are used to convey persons, goods, etc. In particular, the term covers motor vehicles for conveying persons.

The vehicle preferably comprises an environmental sensor system which is configured to capture surroundings data. The environmental sensor system preferably comprises at least one LiDAR system and/or at least one radar system and/or at least one camera and/or at least one ultrasonic system and/or at least one laser scanner. The environmental sensor system can provide the surroundings data (also referred to as “environmental data”) which represent an area surrounding the vehicle.

The vehicle preferably comprises a driving assistance system for automated driving. The driving assistance system may be configured to carry out automated driving using the aspects described in this document for tracking extended objects.

Within the context of the document, the term “automated driving” may be understood as meaning driving with automated longitudinal or lateral guidance or autonomous driving with automated longitudinal and lateral guidance. Automated driving may be, for example, driving on the freeway for a relatively long period of time or driving for a limited period of time while parking or maneuvering. The term “automated driving” comprises automated driving with any degree of automation. Exemplary degrees of automation are assisted, partially automated, highly automated or fully automated driving. These degrees of automation were defined by the German Federal Highway Research Institute (BASt) (see BASt publication “Forschung kompakt”, November 2012 edition).

During assisted driving, the driver permanently carries out the longitudinal or lateral guidance, whereas the system undertakes the respective other function within certain limits. During partially automated driving, the system undertakes the longitudinal and lateral guidance for a certain period of time and/or in specific situations, in which case the driver must permanently monitor the system, as in the case of assisted driving. During highly automated driving, the system undertakes the longitudinal and lateral guidance for a certain period of time without the driver having to permanently monitor the system; however, the driver must be able to undertake vehicle guidance within a certain time. During fully automated driving, the system can automatically manage driving in all situations for a specific application; a driver is no longer required for this application.

The four degrees of automation mentioned above correspond to SAE levels 1 to 4 of the SAE J3016 standard (SAE—Society of Automotive Engineering). For example, highly automated driving corresponds to level 3 of the SAE J3016 standard. Furthermore, SAE level 5 is also provided in SAE J3016 as the highest degree of automation, which is not included in the definition by the BASt. SAE level 5 corresponds to driverless driving, in which the system can automatically manage all situations like a human driver during the entire journey; a driver is generally no longer required.

### BRIEF DESCRIPTION OF THE DRAWINGS

Exemplary embodiments of the disclosure are illustrated in the figures and are described in more detail below.

### BRIEF DESCRIPTION OF THE DRAWINGS

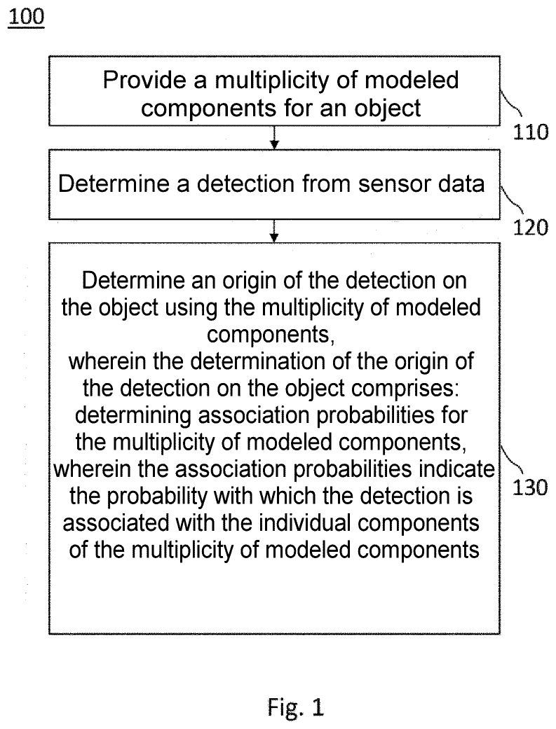

FIG. 1 shows a flowchart of a method for tracking extended objects in vehicle surroundings according to embodiments of the present disclosure,

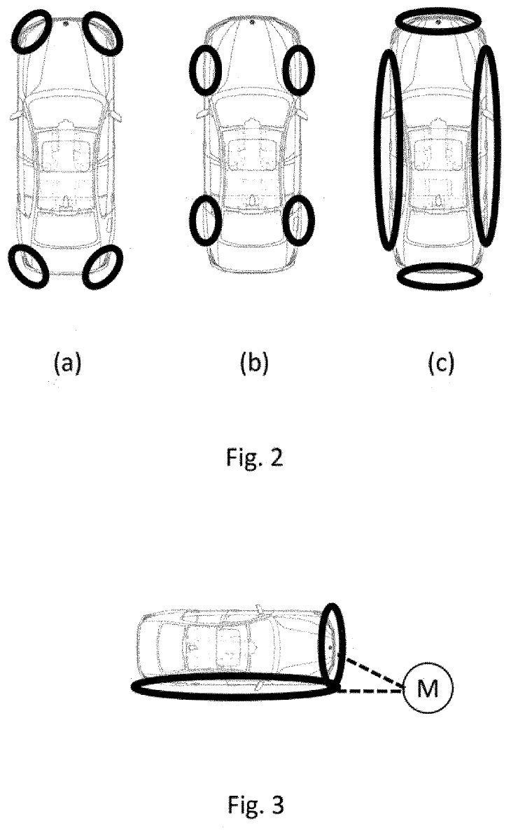

FIG. 2 shows components of a vehicle according to embodiments of the present disclosure,

FIG. 3 shows use of a probabilistic data association filter for determining association probabilities according to exemplary embodiments of the present disclosure,

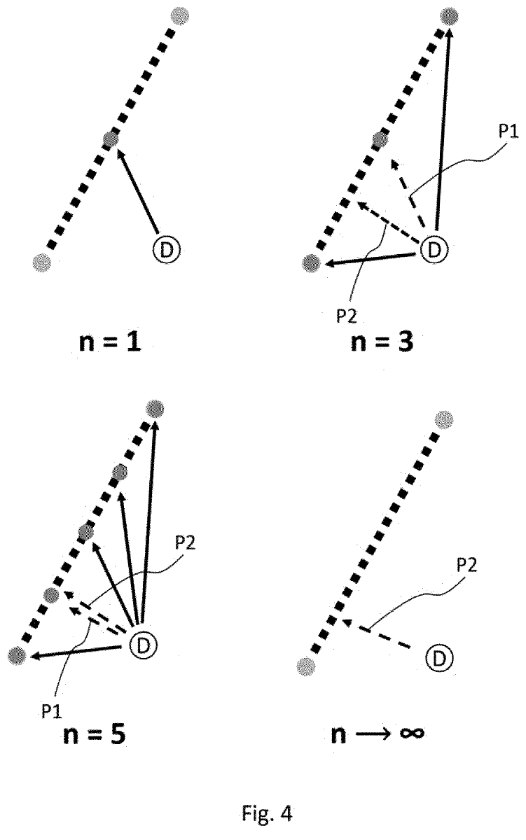

FIG. 4 shows an exemplary continuous association on the basis of a line and a detection that has its origin at an unknown point on the line, and

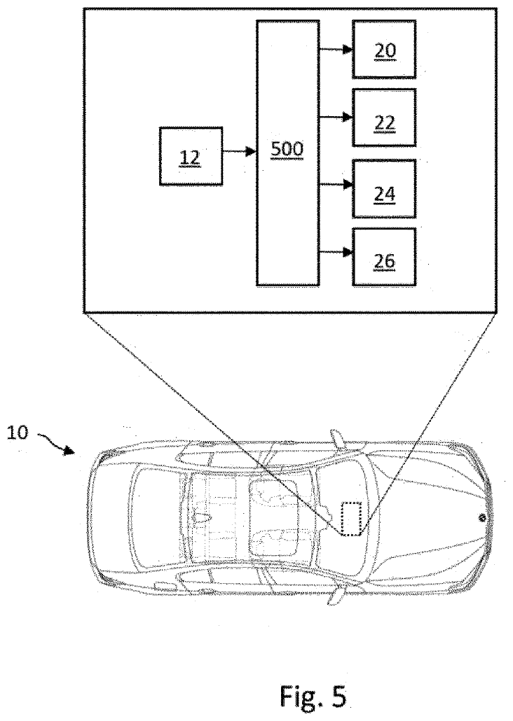

FIG. 5 schematically shows a vehicle having a driving assistance system for automated driving according to embodiments of the present disclosure.

### DETAILED DESCRIPTION OF THE DRAWINGS

Unless noted otherwise, the same reference signs are used below for identical and identically acting elements.

Usually only a few detections are discernible in mass-produced sensors, in particular radar sensors, and the measurement data alone are insufficient to estimate the object state. In this case, it is possible to use, for example, a radar measurement model which describes what object state and what object structure produce which measurement data. This knowledge can be used in a Bayesian filter to infer an object state (object position and object orientation) from measurement data. However, such radar measurement models are very computationally intensive and can be used, for example, only together with a particle filter which is likewise computationally intensive.

According to the invention, a plurality of components are modeled for an individual object, such as a vehicle. The plurality of components may comprise, for example, at least one wheel, at least one vehicle corner and at least one vehicle side. Association probabilities for each of these components are then determined for an individual detection obtained from real sensor data. In other words, a probabilistic association that can be determined quickly and with little computing complexity is carried out. This makes it possible to track extended objects with reduced computing resources and in a reduced amount of time.

FIG. 1 schematically shows a flowchart of a method 100 for tracking extended objects, in particular in vehicle surroundings, according to embodiments of the present disclosure.

The method 100 can be implemented by means of appropriate software which can be executed by one or more processors (for example a CPU).

In block 110, the method 100 comprises providing a multiplicity of modeled components for an (individual) object; in block 120, it comprises determining a detection from sensor data; and, in block 130, it comprises determining an origin of the detection on the object using the multiplicity of modeled components. The determination of the origin of the detection on the object comprises determining association probabilities for the multiplicity of modeled components, wherein the association probabilities indicate the probability with which the detection is associated with the individual components of the multiplicity of modeled components or the probability with which the detection comes from the individual components.

Subdividing the object into components and following an accurate (radar) measurement model enable more precise tracking than is possible with very simple approximations, for example. Since the calculation of the detection probabilities can be derived from physical parameters, flexible use is additionally also possible. For example, different sensor installation heights and/or object sizes may be taken into account, which is advantageous for use in vehicles.

The probabilistic association according to the invention can also be calculated quickly since state updates need to be calculated only for a limited number of components. In contrast, traditional approaches, for example particle filters, calculate a large number of object state hypotheses by comparing each hypothesis with the measurement data and calculating a probability of this hypothesis. This makes it possible to use the method according to the invention on control devices with limited computing power, as are present in vehicles, for example.

The method according to the invention also allows the assignment of noisy measurement data. Many traditional approaches imply that at least one variable (for example the angle from the object at which the detection is measured) is noise-free. This is incorrect in practice and results in the detection being filtered at an actually incorrect point. The method according to the invention inherently solves this problem since every possible origin source with its respective probability contributes to updating the object state estimation.

FIG. 2 shows an exemplary subdivision of an object into a discrete number of components. For example, a vehicle can be abstracted into highly reflective components. FIG. 2(a) shows body corners, FIG. 2(b) shows wheels and FIG. 2(c) shows body sides.

Each component is a possible origin for a radar detection. For example, a detection in the rear left-hand corner of a vehicle has a high association probability with its left-hand rear wheel or the rear left-hand corner of the body. The association also benefits, for example, from radial speed measurements by the radar. For example, a micro-Doppler of a wheel is identified and is used for the assignment to a wheel.

In some embodiments, the association probabilities are determined by means of a probabilistic data association filter. In particular, an adaptation of the PDAF, as illustrated in FIG. 3, is used to link a detection M to a number of possible origins of an (individual) target and to carry out corresponding filtering. This adaptation comprises a single detection and a plurality of discrete origins which are linked to a single object.

Measurement functions describe the expected measurement for each origin using the state estimation and corresponding transformations. A known disadvantage of the PDAF is that incorrect association hypotheses are always filtered with a particular weight. Incorrect hypotheses are identified and resolved using multi-hypothesis trackers, for example. Multi-hypothesis trackers identify that an incorrect hypothesis was selected at an earlier time and retroactively choose a correct hypothesis. However, this requires the spanning and permanent calculation of a hypothesis tree which grows exponentially over time. As a result, multi-hypothesis trackers have an extremely high computing time requirement; usually only approximations of them are encountered in industry.

In contrast, in the adaptation according to the invention, all origins are located on the rigid body of the target and are therefore dynamically linked. The state updates of incorrect associations are highly likely to be similar to the correct associations, in particular since origins have a significant likelihood of being close to one another. This effect enables robust use of the PADF. The association problem is therefore solved in a probabilistic manner, that is to say all hypotheses are filtered with their association probability. Although it may be the case that incorrect hypotheses are filtered, on average the approach according to the invention tracks correctly within reasonable tolerances.

The wheels and the body corners of a vehicle may be approximated by discrete Gaussian ellipses, their extent being modeled with an additive term relating to the position uncertainty. However, this approach causes a high degree of distortion in larger extended parts such as the body sides. In order to eliminate this disadvantage, at least one component of the multiplicity of modeled components is subdivided into a multiplicity of subcomponents in some embodiments, wherein a corresponding association probability is determined for each subcomponent of the multiplicity of subcomponents. This is also referred to as “continuous association”.

FIG. 4 shows an exemplary continuous association on the basis of a line and a detection D which has its origin at an unknown point on the line. A possible approach now involves defining any desired number of sampling points n and carrying out a discrete assignment.

For n=1, the detection D is always assigned to a single point given by the center of the line.

If the number of sampling points is increased to n=3, the result is three association hypotheses with a different probability. The arrow P1 indicates the hypothesis with the highest probability. Choosing the hypothesis with the highest probability is referred to as “hard association”. The arrow P2 indicates a weighted mean value of the state update, which is referred to as “soft association”.

The accuracy is improved by further increasing the number of sampling points, for example to n=5. However, the computing complexity also increases. It is possible for the number of sampling points providing the desired precision to already exceed the available budget of computing time.

This can be solved by using an infinite number of sampling points (n=∞). Integrating the association equations along the line results in optimum precision and only a single function which needs to be evaluated.

FIG. 5 schematically shows a vehicle 10 having a driving assistance system 500 for automated driving according to embodiments of the present disclosure.

During automated driving, the longitudinal and lateral guidance of the vehicle 10 is carried out automatically. The driving assistance system 500 therefore undertakes the vehicle guidance. For this purpose, the driving assistance system 500 controls the drive 20, the transmission 22, the hydraulic service brake 24 and the steering system 26 using intermediate units, which are not illustrated.

In order to plan and carry out automated driving, surroundings information from a surroundings sensor system, which observes the vehicle surroundings, is received by the driver assistance system 500. In particular, the vehicle may comprise at least one environmental sensor 12 which is configured to acquire environmental data indicating the vehicle surroundings. The at least one environmental sensor 12 may comprise, for example, one or more LiDAR systems, one or more radar systems, one or more ultrasonic systems, one or more laser scanners and/or one or more cameras.

The environmental data are used, in particular, to identify and track objects in the environment of the vehicle. In this case, the tracking can be carried out using the methods and systems described in this document. For example, the driver assistance system 500 may comprise a storage medium in which data relating to a multiplicity of objects may be stored, wherein corresponding modeled components for each of the multiplicity of objects may be present, or stored, on the storage medium.

According to the invention, a plurality of components are modeled for an individual object, such as a vehicle. The plurality of components may comprise, for example, at least one wheel, at least one vehicle corner and at least one vehicle side. Association probabilities for each of these components are then determined for an individual detection obtained from real sensor data. In other words, a probabilistic association that can be determined quickly and with little computing complexity is carried out. This makes it possible to track extended objects with reduced computing resources and in a reduced amount of time.

Although the invention has been explained and illustrated more specifically in detail by means of preferred exemplary embodiments, the invention is not restricted by the disclosed examples and other variations can be derived therefrom by a person skilled in the art without departing from the scope of protection of the invention. It is therefore clear that there are a multiplicity of possible variations. It is likewise clear that embodiments mentioned by way of example are actually only examples which cannot be interpreted in any way as limiting the scope of protection, the possible applications or the configuration of the invention, for instance. Rather, the above description and the description of the figures make it possible for a person skilled in the art to specifically implement the exemplary embodiments, wherein a person skilled in the art, with knowledge of the disclosed concept of the invention, can make various modifications, for example with regard to the function or the arrangement of individual elements mentioned in an exemplary embodiment, without departing from the scope of protection defined by the claims and their legal equivalents, for instance further explanations in the description.

1-10. (canceled)

11. A method for tracking extended objects, comprising:
providing a plurality of modeled components for an object;
determining a detection from sensor data; and
determining an origin of the detection on the object using the plurality of modeled components, wherein determining the origin of the detection on the object comprises:
determining association probabilities for the multiplicity of modeled components, wherein the association probabilities indicate the probability with which the detection is associated with the individual components of the plurality of modeled components.

12. The method of claim 11, wherein the association probabilities are input into a probabilistic data association filter.

13. The method of claim 11, wherein determining the origin of the detection on the object further comprises: updating a state estimation relating to the object using the association probabilities.

14. The method of claim 11, wherein at least one component of the plurality of modeled components is modeled by a point target with a Gaussian noise term.

15. The method of claim 11,
wherein at least one component of the plurality of modeled components is subdivided into a plurality of subcomponents, and
wherein a corresponding association probability is determined for each subcomponent of the plurality of subcomponents.

16. The method of claim 11, wherein the plurality of modeled components are selected from the group consisting of a vehicle wheel, a vehicle corner and a vehicle side.

17. The method of claim 11,
wherein the sensor data is provided by at least one sensor, and
wherein the at least one sensor is selected from the group consisting of: a LiDAR sensor and a RADAR sensor.

18. A non-transitory computer-readable medium storing a software program whose execution by a computer configures the computer to carry out the method of claim 11.

19. A system, comprising one or more processors collectively configured to carry out the method of claim 11.

20. A motor vehicle, comprising:
one or more processors collectively configured to carry out the method of claim 11.
